(19) United States
(12) Patent Application Publication
(10) Pub. No.: US 2026/0221068 A1
(43) Pub. Date: Jul. 30, 2026

(54) DRIVING DEVICE AND DISPLAY APPARATUS

(71) Applicant: WUHAN CHINA STAR OPTOELECTRONICS SEMICONDUCTOR DISPLAY TECHNOLOGY CO., LTD., Wuhan, Hubei (CN)

(72) Inventors: Miaorong CAI, Wuhan, Hubei (CN); Qingsheng LAN, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 19/144,479

(22) PCT Filed: Nov. 1, 2024
(86) PCT No.: PCT/CN2024/129267

§ 371 Date: Jun. 29, 2025

(30) Foreign Application Priority Data
Nov. 27, 2023 (CN) 202311614218.1

(51) Int. Cl. G09G 3/20

(52) U.S. Cl. CPC G09G 3/2007; G09G 2310/027; G09G 2330/021

(57) ABSTRACT

A driving device and a display device. The driving device comprises a voltage amplification module and a plurality of source drivers. On the basis of a received gamma voltage, the voltage amplification module generates a corresponding target gamma voltage, and input terminals of the plurality of the source drivers are connected to output terminals of the voltage amplification modules, so as to output the corresponding gray scale voltage.

This application claims priority to Chinese Patent Application No. 202311614218.1, filed on Nov. 27, 2023. The entire content of the Chinese patent application is hereby incorporated by reference.

### TECHNICAL FIELD

The present application relates to, but is not limited to the field of display technology, and more particularly, relates to a driving device and a display apparatus.

### BACKGROUND

With the development of display technology, the size of products with resolutions of 4K and above is getting larger and larger. Consequently, lines of gamma voltage on the printed circuit board assembly will relatively become longer, which leads to an increase in impedance and a greater voltage drop. In the related technologies, each source driver needs to add a voltage amplification module to each gamma voltage path to avoid the display brightness difference of the panel caused by the gamma voltage drop.

When there are a plurality of channels of gamma voltage, each source driver requires a plurality of voltage amplification modules, thereby resulting in an increase in the size and power consumption of the source driver.

### SUMMARY

Embodiments of the application provide a driving device and a display apparatus to solve the problem that when there are a plurality of channels of gamma voltage, a plurality of voltage amplification modules are needed in each source driver, which leads to an increase in the size and power consumption of the source driver.

To solve the aforementioned issues, the technical solutions provided by the application are as follows:
In a first aspect, an embodiment of the present application provides a driving device for driving a display panel. The driving device includes a printed circuit board, and a plurality of source driver connected to the printed circuit board. Herein a plurality of signal transmission lines are arranged on the printed circuit board, all of which are connected to each of the source drivers. Herein each of the source drivers comprises a voltage amplification module, an output terminal of the voltage amplification module is electrically connected to one of the signal transmission lines, an input terminal of the voltage amplification module is connected to a gamma signal source to receive initial gamma voltages, and the voltage amplification module is configured to amplify the initial gamma voltages to target gamma voltages, and output the target gamma voltages to the corresponding source drivers via the signal transmission line.

In a second aspect, an embodiment of the present application provides a display apparatus, which includes a display panel and the driving device as described in any of the embodiments of the first aspect. The driving device includes a printed circuit board and a plurality of source drivers connected to the printed circuit board. Herein a plurality of signal transmission lines are arranged on the printed circuit board, all of which are connected to each of the source drivers. Herein each of the source drivers includes a voltage amplification module, an output terminal of the voltage amplification module is electrically connected to one of the signal transmission lines, an input terminal of the voltage amplification module is connected to a gamma signal source to receive initial gamma voltages, and the voltage amplification module is configured to amplify the initial gamma voltages to target gamma voltages, and output the target gamma voltages to corresponding source drivers according to the signal transmission line.

### BRIEF DESCRIPTION OF THE DRAWINGS

FIG. 1 is a schematic structural diagram of the circuit of the driving device in the related technologies.

FIG. 2 is a schematic structural diagram of the display apparatus of the application;

FIG. 3 is a schematic structural diagram of the circuit of part of the driving device shown in FIG. 2.

FIG. 4 is a schematic diagram of the connection relationship of a part of the source drivers in an embodiment of the present application.

### DETAILED DESCRIPTION

In order to make purposes, technical solutions and effects of the present application clearer and more explicit, the following provides a further detailed explanation of the present application with reference to the accompanying drawings and embodiments. It should be understood that the specific embodiments described herein are merely intended to explain the present application, and are not intended to limit it.

In an embodiment, a voltage amplification module includes a voltage follower unit. A first input terminal of the voltage follower unit is electrically connected to a gamma signal source, and a second input terminal of the voltage follower unit and an output terminal of the voltage follower unit are electrically connected to a signal transmission line. The voltage input unit is configured to make a target gamma voltage on the transmission signal line equal to an initial gamma voltage.

In an embodiment, the voltage follower unit includes an operational amplifier. A non-inverting input terminal of the operational amplifier is electrically connected to the gamma signal source to receive the initial gamma voltage, and an inverting input terminal of the operational amplifier and an output terminal of the operational amplifier are electrically connected to a corresponding one of the signal transmission lines.

In an embodiment, a driving device includes a plurality of gamma signal lines, which are connected to the gamma signal source to transmit the initial gamma voltage. And herein among the plurality of gamma signal lines, part of the gamma signal lines are electrically connected to the voltage amplification module, and the other part of the gamma signal lines are electrically connected to a signal transmission line.

In an embodiment, each of the source drivers comprises a digital-to-analog conversion module. A plurality of input terminals of the digital-to-analog conversion module are connected to the plurality of signal transmission lines in one-to-one correspondence. The digital-to-analog conversion module generates a plurality of corresponding gray scale voltages according to the voltages on the plurality of signal transmission lines.

In an embodiment, a plurality of initial gamma voltages comprise a first gamma voltage, a second gamma voltage, and a third gamma voltage with progressively increasing voltage values. The digital-to-analog conversion module generates a first gray scale voltage and a third gray scale voltage, respectively. according to the first gamma voltage and the third gamma voltage. One of the first gray scale voltage and the third gray scale voltage enables the driving device to display a white image, and the other one enables the driving device to display a black image. Herein the gamma signal lines providing the first gamma voltage and the third gamma voltage are electrically connected to the transmission lines, and the gamma signal lines providing the second gamma voltage are electrically connected to the corresponding voltage amplification module.

In an embodiment, the voltage amplification module includes a voltage follower unit. A first input terminal of the voltage follower unit is electrically connected to the gamma signal line, and a second input terminal of the voltage follower unit and an output terminal of the voltage follower unit are electrically connected to signal transmission lines, the voltage input unit is configured to make the target gamma voltage on the transmission signal equal to the initial gamma voltage on the transmission signal line.

In an embodiment, the voltage follower unit includes an operational amplifier. A non-inverting input terminal of the operational amplifier is electrically connected to the gamma signal line to receive the gamma voltage, and an inverting input terminal of the operational amplifier and the output terminal of the operational amplifier are electrically connected to a corresponding signal transmission lines.

In an embodiment, each of the source drivers comprises a digital-to-analog conversion module. A plurality of input terminals of the digital-to-analog conversion module are connected to the plurality of signal transmission lines in one-to-one correspondence. The digital-to-analog conversion module generates a plurality of corresponding gray scale voltages according to the voltages on the plurality of signal transmission lines.

Beneficial effects of the present application are as follows: in the present embodiment, by setting the voltage amplification module, the voltage amplification module can receive the initial gamma voltage and transmit the corresponding target gamma voltage generated according to the initial gamma voltage to each of the source drivers, thus avoiding the need to set a plurality of amplification modules in each of the source drivers to amplify the gamma voltage. This reduces the size of the source drivers, lowers the power consumption of the source drivers, and improves the technical problem in the related technologies that a plurality of voltage amplification modules need to be set in each source driver, which leads to an increase in the size of the source drivers and an increase in power consumption.

With the development of display technology, the size of products with resolutions of 4K and above is getting larger and larger. Consequently, lines of gamma voltage on the control circuit board assembly will relatively become longer, which leads to an increase in impedance and a greater voltage drop. Each source driver needs to add a voltage amplification module to each gamma voltage path to avoid the display brightness difference of the panel caused by the gamma voltage drop.

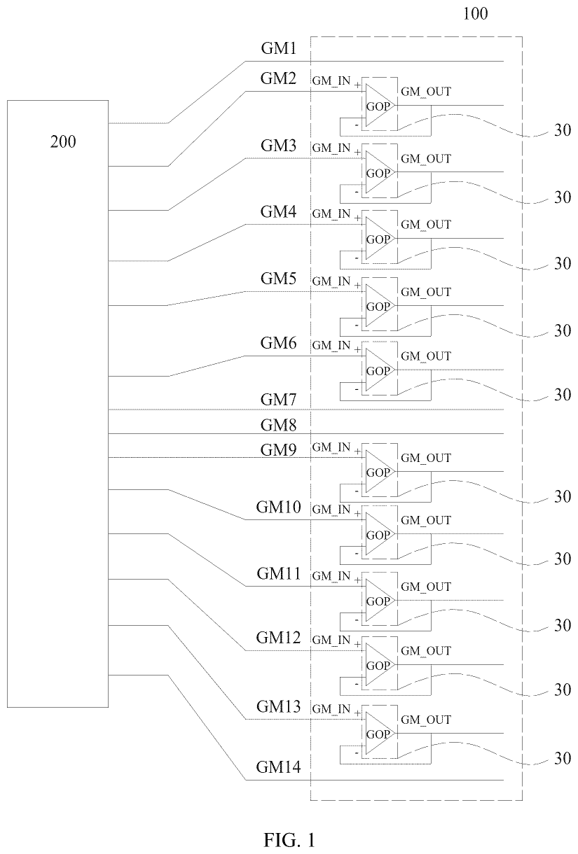

In related technologies, as shown in FIG. 1, the driving device includes a control circuit board 200 and a source driver 100. When there are a plurality of channels of gamma voltage, a plurality of voltage amplification modules need to be set in the source driver 100. Each voltage amplification module amplifies the gamma voltage of one channel, and the amplified gamma voltage is then converted into grayscale voltage by other modules inside the source driver 100. Since a plurality of voltage amplification modules need to be set in the source driver 100, it leads to an increase in the size of the source drivers 100 and increased power consumption.

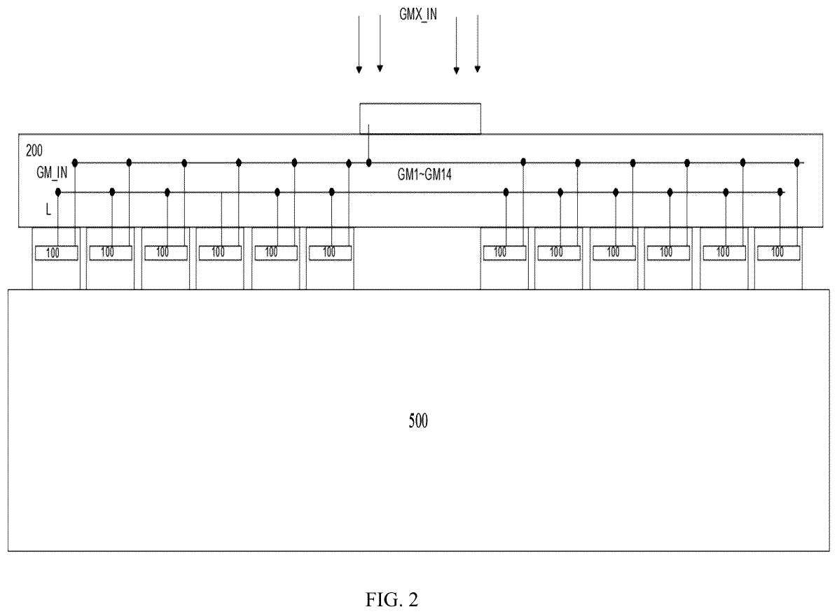

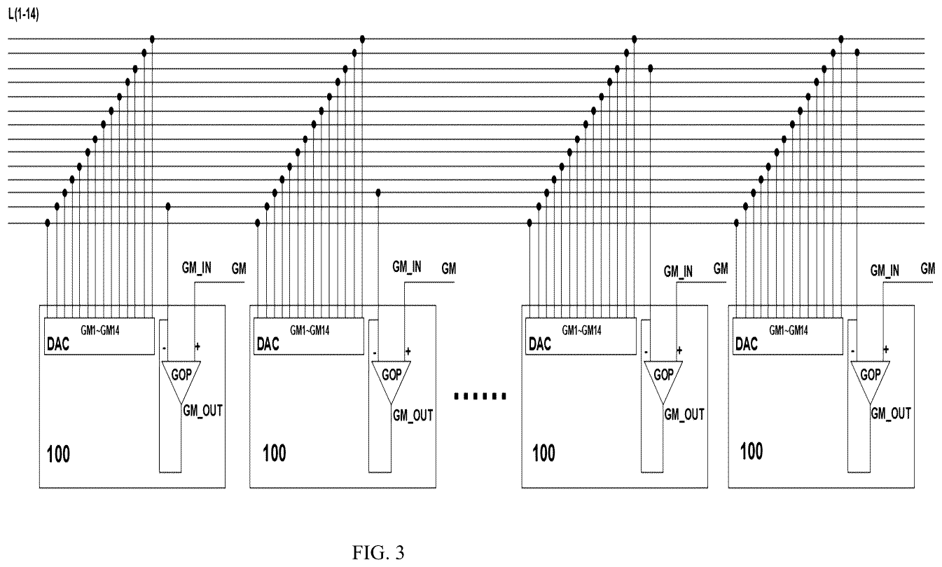

To resolve the aforementioned issues, embodiments of the application provide a driving device. As show in FIG. 2 and FIG. 3, the driving device includes a plurality of source drivers 100 and a control circuit board 200. The control circuit board 200 is configured to receive an initial signal GMX_IN, which includes a plurality of initial gamma voltages GM. A plurality of signal transmission lines (L1 to L14) are arranged on the control circuit board 200. The plurality of signal transmission lines are connected to each of the source drivers 100.

Each of the source drivers 100 includes a voltage amplification module. The voltage amplification module is configured to receive a plurality of initial gamma voltages GM, and generate correspondingly a plurality of target gamma voltages according to the received plurality of initial gamma voltages GM.

Each input terminal of the plurality of the source electrode drivers 100 is connected to an output terminal of the voltage amplification module, so as to receive the target gamma voltage output by the voltage amplification module, and output a corresponding gray scale voltage according to the target gamma voltage. It should be understood that, since a plurality of the voltage amplification modules receive the plurality of initial gamma voltages GM, and output the plurality of target gamma voltages generated by the voltage amplification module to the input terminals of each of the multiple source drivers 100, it is unnecessary to set a plurality of amplification modules in each of the source drivers 100 to amplify the initial gamma voltage GM, which reduces the size of the source drivers 100 and lowers the power consumption of the source drivers.

In the present embodiment, by setting the voltage amplification module, the voltage amplification module can receive the initial gamma voltage GM and transmit the corresponding target gamma voltage generated according to the initial gamma voltage to each of the source drivers, thereby avoiding the need to set a plurality of amplification modules in each of the source drivers 100 to amplify the initial gamma voltage GM. This reduces the size of the source drivers 100, lowers the power consumption of the source drivers 100, and improves the technical problem in the related technologies that a plurality of voltage amplification modules need to be set in each of the source driver 100, which leads to an increase in the size of the source drivers 100 and an increase in power consumption.

In an embodiment, the voltage amplification module includes a voltage follower unit GOP. Each of the voltage follower unit GOP receives an initial gamma voltage GM, and generates a corresponding target gamma voltage according to the initial gamma voltage GM it has received. It should be understood that, a number of voltage follower units GOP is the same as a number of initial gamma voltages GM that need to be amplified. However, the number of voltage follower units GOP may not necessarily be the same as the total number of initial gamma voltages GM.

The input terminals of the plurality of source drivers 100 are connected to output terminals GM_OUT of a plurality of voltage follower units GOP through the plurality of signal transmission lines, so as to receive the target gamma voltage output by the voltage follower units GOP, and to output the corresponding gray scale voltage according to the target gamma voltage. It should be understood that, since each of the voltage follower units GOP receives one initial gamma voltage GM, and outputs the generated target gamma voltage to the plurality of source drivers 100, it is unnecessary to set multiple voltage follower units GOP in each of the source drivers 100 to amplify the initial gamma voltage GM, which reduces the size of the source drivers 100 and lowers the power consumption of the source drivers 100.

In the present embodiment, by setting the voltage follower unit GOP, each GOP receives the initial gamma voltage GM and outputs the generated target gamma voltage to the plurality of source driver 100, thereby avoiding the need to set a plurality of voltage follower units GOP in each of the source drivers 100 to amplify the initial gamma voltage GM. This reduces the size of the source drivers 100, lowers the power consumption of the source driver 100, and improves the technical problem in the related technologies that a plurality of voltage amplification modules need to be set in the source driver 100, which leads to an increase in the size of the source drivers 100 and an increase in power consumption.

In an embodiment, the voltage follower unit GOP includes an operational amplifier. A non-inverting input terminal GM_IN of the operational amplifier is configured to receive the initial gamma voltage GM. An inverting input terminal of the operational amplifier are electrically connected to the output terminal GM_OUT of the operational amplifier. The output terminal GM_OUT of the operational amplifier is configured to output the target gamma voltage.

In an embodiment, the driving device includes a plurality of gamma signal lines and the plurality of signal transmission lines. Each gamma signal line GM_IN is configured to receive one initial gamma voltage GM, meaning that the gamma signal line is electrically connected to the gamma signal source on the control circuit board to generate the gamma signal. Each non-inverting input terminal GM_IN of the operational amplifier is electrically connected to one gamma signal line, and each output terminal GM_OUT of the operational amplifier is electrically connected to one signal transmission line. The operational amplifier amplifies the initial gamma voltage GM on the gamma signal line and then outputs the target gamma voltage to the signal transmission line. It should be understood that, since the non-inverting input terminal GM_IN of the operational amplifier receives the initial gamma voltage GM, and the inverting input terminal is electrically connected to the output terminal GM_OUT of the operational amplifier, according to the fact that the input impedance of an ideal operational amplifier is infinite, it can be known that the current flowing into and out of the non-inverting input terminal GM_IN of the operational amplifier is zero, that is, there is no current. This results in that there is almost no voltage drop on the connecting line (i.e. the gamma signal line) that connects the operational amplifier and the source driver 100. Consequently, the initial gamma voltage GM without voltage drop is output from the output terminal of the operational amplifier, which is the target gamma voltage.

The source driver 100 includes a digital-to-analog conversion module (not shown) configured to convert the initial gamma voltage GM into the gray scale voltage. An input terminal of the digital-to-analog conversion module (i.e., the input terminal of the source driver 100) is electrically connected to the plurality of signal transmission lines. The digital-to-analog conversion module is configured to generate a plurality of gray scale voltages according to the target gamma voltage on the signal transmission lines.

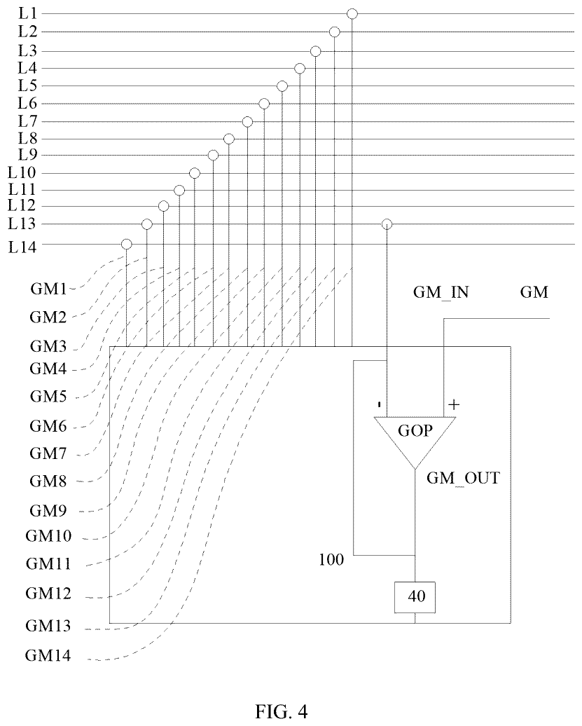

As shown in FIG. 4, in some embodiments, the gamma signal source collectively provides 14 initial gamma voltages GM (GM1~GM14). Correspondingly, there are 14 gamma signal lines, and each gamma signal line delivering one of the initial gamma voltages GM. The non-inverting input terminal GM_IN of each voltage follower unit GOP is electrically connected to one of the gamma signal lines, and to generate the corresponding target gamma voltage according to the corresponding initial gamma voltage GM. Each output terminal GM_OUT of the voltage follower unit GOP is electrically connected to one of the signal transmission lines, so as to deliver the generated target gamma voltage to the signal transmission line. Accordingly, a number of the voltage follower units GOP and a number of the signal transmission lines is also 14. The input terminals of the digital-to-analog conversion modules within each of the source drivers 100 are electrically connected to the 14 signal transmission lines respectively, so as to generate the gray scale voltage according to the corresponding target gamma voltage on the signal transmission line N.

In some embodiments, the initial gamma voltage GM is a digital voltage, the gray scale voltage is an analog voltage, and the digital-to-analog conversion module is a digital-to-analog converter.

It should be clarified that, the number of voltage follower units GOP is determined by the initial gamma voltages GM that need to be amplified. As described in the aforementioned embodiments, since each initial gamma voltage GM needs to be amplification, the number of voltage follower units GOP is equal to the number of initial gamma voltages GM. In some embodiments, only a part of the initial gamma voltage GM needs to be amplified. In this case, the number of voltage-following units GOP is not equal to the number of initial gamma voltages GM.

In an embodiment, among the plurality of gamma signal lines, some of the gamma signal lines are electrically connected to the voltage amplification module, while the other part of the gamma signal lines are electrically connected to the signal transmission line. Specifically, the gamma signal source provides a total of 14 initial gamma voltages GM (GM 1~GM 14). Correspondingly, there are also 14 gamma signal lines, and each of which transmits one initial gamma voltage GM. Herein, the plurality of initial gamma voltages GM include a first gamma voltage, a second gamma voltage, and a third gamma voltage with progressively increasing voltage values. The digital-to-analog conversion module generates a first gray scale voltage and a third gray scale voltage according to the first gamma voltage and the third gamma voltage, respectively. One of the first gray scale voltage and the third gray scale voltage enables the driving device to display a white image, and the other one of them enables the driving device to display a black image. The first digital-to-analog conversion module generates a second gray scale voltage according to the second gamma voltage, and the second gray scale voltage enables the driving device to generate other images different from the white image and the black image. The first gamma voltage and the third gamma voltage together include 4 initial gamma voltages GM (GM 1, GM 7, GM 8, and GM 14), while the second gamma voltage includes 10 initial gamma voltages GM (GM 2 to GM 6, GM 9 to GM 13).

Since the human eye cannot perceive the voltage differences caused by line resistance when displaying black and white images, the gamma signal line that provides the first gamma voltage and the third gamma voltage is directly electrically connected to the signal transmission line without passing through the voltage follower unit GOP amplification. Thus, at this time, it is only necessary to set 10 voltage follower units GOP. The non-inverting input terminal GM_IN of each voltage follower unit GOP is electrically connected to one gamma signal line, so as to generate the corresponding target gamma voltage according to the corresponding initial gamma voltage GM. The output terminal GM_OUT of each of the voltage follower units GOP is electrically connected to one signal transmission line, so as to transmit the generated target gamma voltage according to the signal transmission line. That is to say, the number of the signal transmission lines is also fourteen. Among them, ten signal transmission lines are electrically connected to the output terminal GM_OUT of the voltage follower unit GOP, and the remaining four signal transmission lines are electrically connected to the gamma signal line. Therefore, at this time, there are signal transmission lines to transmit the target gamma voltage as well as signal transmission lines to transmit the initial gamma voltage GM.

The input terminal of each digital-to-analog conversion module within each source driver 100 are electrically connected to the 14 signal transmission lines, respectively, so that they can receive the initial gamma voltage GM and the target gamma voltage on the signal transmission lines, and generate the gray scale voltage according to the corresponding initial gamma voltage GM and the target gamma voltage.

It should be understood that, through the above configuration, compared to the aforementioned embodiments, the number of voltage follower units GOP is reduced, thereby decreasing the size of source driver 100 and reducing its power consumption.

In some embodiments, the initial gamma voltage GM is a digital voltage, the gray scale voltage is an analog voltage, and the digital-to-analog conversion module is a digital-to-analog converter.

In a second aspect, an embodiment of the present application further provides a display apparatus, which includes a display panel 500 and the driving device as described in any of the aforementioned embodiments.

Those of ordinary skill in the art should understand that the embodiments of the present application can be modified or equivalent substitutions without departing from the spirit and scope of the present application. Such modifications or equivalent substitutions should be encompassed within the scope of the present application. Each embodiment may be combined with others, but will not be redundantly described one by one.

The principles and embodiments of the present application have been illustrated through specific examples within this document. The descriptions of the aforementioned embodiments are intended to facilitate the understanding of the methods and core concepts of the application. Furthermore, for those skilled in the art, according to the idea of the present application, there can be modifications in the specific implementation methods and application scopes. In conclusion, the content of this specification should not be construed as limiting the application.

1. A driving device for driving a display panel, wherein the driving device comprises a control circuit board, and a plurality of source drivers connected to the control circuit board,
wherein a plurality of signal transmission lines are arranged on the control circuit board, and the plurality of signal transmission lines are connected to each of the source drivers; and
wherein each of the source drivers comprises a voltage amplification module, an output terminal of the voltage amplification module is electrically connected to one of the signal transmission lines, an input terminal of the voltage amplification module is connected to a gamma signal source to receive initial gamma voltages, and the voltage amplification module is configured to amplify the initial gamma voltages to target gamma voltages, and output the target gamma voltages to the corresponding source drivers via the signal transmission line.

2. The driving device according to claim 1, wherein the voltage amplification module comprises a voltage follower unit, a first input terminal of the voltage follower unit is electrically connected to the gamma signal source, and a second input terminal of the voltage follower unit and an output terminal of the voltage follower unit are electrically connected to one of the signal transmission lines, the voltage follower unit is configured to make the target gamma voltage on the transmission signal line equal to the initial gamma voltage.

3. The driving device according to claim 2, wherein the voltage follower unit comprises an operational amplifier, a non-inverting input terminal of the operational amplifier is electrically connected to the gamma signal source to receive the initial gamma voltage, and an inverting input terminal of the operational amplifier and an output terminal of the operational amplifier are electrically connected to a corresponding one of the signal transmission lines.

4. The driving device according to claim 3, wherein the driving device further comprises a plurality of gamma signal lines configured to be connected to the gamma signal source to transmit the initial gamma voltage, and wherein among the plurality of gamma signal lines, a part of the gamma signal lines are electrically connected to the voltage amplification module, and another part of the gamma signal lines are electrically connected to the signal transmission lines.

5. The driving device according to claim 4, wherein each of the source drivers comprises a digital-to-analog conversion module, a plurality of input terminals of the digital-to-analog conversion module are connected to the plurality of signal transmission lines in one-to-one correspondence, the digital-to-analog conversion module generates a plurality of corresponding gray scale voltages according to the voltages on the plurality of signal transmission lines.

6. The driving device according to claim 5, wherein a plurality of initial gamma voltages comprise a first gamma voltage, a second gamma voltage, and a third gamma voltage with progressively increasing voltage values, the digital-to-analog conversion module generates a first gray scale voltage and a third gray scale voltage respectively according to the first gamma voltage and the third gamma voltage, one of the first gray scale voltage and the third gray scale voltage enables the driving device to display a white image, and the other one enables the driving device to display a black image;
wherein the gamma signal lines providing the first gamma voltage and the third gamma voltage are electrically connected to the transmission lines, and the gamma signal lines providing the second gamma voltage are electrically connected to the corresponding voltage amplification module.

7. The driving device according to claim 5, wherein the digital-to-analog conversion module is a digital-to-analog converter.

8. The driving device according to claim 5, wherein the initial gamma voltage is a digital voltage, and the gray scale voltage is an analog voltage.

919. The driving device according to claim 2, wherein each of the initial gamma voltages is amplified, and a number of the voltage follower units is equal to a number of the initial gamma voltages.

10. The driving device according to claim 2, wherein a part of the initial gamma voltages are amplified, and a number of voltage follower units is not equal to a number of the initial gamma voltages.

11. A display apparatus, comprising a display panel and a driving device 10, wherein the driving device comprises a control circuit board and a plurality of source drivers connected to the control circuit board, wherein a plurality of signal transmission lines are arranged on the control circuit board, and the plurality of signal transmission lines are connected to each of the source drivers;
wherein each of the source drivers includes a voltage amplification module, an output terminal of the voltage amplification module is electrically connected to one of the signal transmission lines, an input terminal of the voltage amplification module is connected to a gamma signal source to receive initial gamma voltages, the voltage amplification module is configured to amplify the initial gamma voltages to target gamma voltages, and output the target gamma voltages to the corresponding source drivers via the signal transmission line.

12. The display apparatus according to claim 11, wherein the voltage amplification module comprises a voltage follower unit, a first input terminal of the voltage follower unit is electrically connected to a gamma signal source and a second input terminal of the voltage follower unit and an output terminal of the voltage follower unit are electrically connected to the signal transmission lines, the voltage follower unit is configured to make the target gamma voltage on the transmission signal line equal to the initial gamma voltage.

13. The display apparatus according to claim 12, wherein the voltage follower unit comprises an operational amplifier, a non-inverting input terminal of the operational amplifier is electrically connected to the gamma signal line to receive the initial gamma voltage, and an inverting input terminal of the operational amplifier and the output terminal of the operational amplifier are electrically connected to the corresponding signal transmission lines.

14. The display apparatus according to claim 16, wherein each of the source drivers comprises a digital-to-analog conversion module, a plurality of input terminals of the digital-to-analog conversion module are connected to the plurality of signal transmission lines in one-to-one correspondence, the digital-to-analog conversion module generates a plurality of corresponding gray scale voltages according to the voltages on the plurality of signal transmission lines.

15. The display apparatus according to claim 14, wherein a plurality of initial gamma voltages comprise a first gamma voltage, a second gamma voltage, and a third gamma voltage with progressively increasing voltage values, the digital-to-analog conversion module generates a first gray scale voltage and a third gray scale voltage respectively according to the first gamma voltage and the third gamma voltage, one of the first gray scale voltage and the third gray scale voltage enables the driving device to display a white screen, and the other one enables the driving device to display a black screen;
wherein the gamma signal lines providing the first gamma voltage and the third gamma voltage are electrically connected to the transmission lines, and the gamma signal lines providing the second gamma voltage are electrically connected to the corresponding voltage amplification module.

16. The display apparatus according to claim 13, wherein the driving device further comprises a plurality of gamma signal lines connected to the gamma signal source to transmit the initial gamma voltage, and wherein among the plurality of gamma signal lines, a part of the gamma signal lines are electrically connected to the voltage amplification module, and another part of the gamma signal lines are electrically connected to the signal transmission lines.

17. The display apparatus according to claim 14, wherein the digital-to-analog conversion module is a digital-to-analog converter.

18. The display apparatus according to claim 14, wherein the initial gamma voltage is a digital voltage, and the gray scale voltage is an analog voltage.

19. The display apparatus according to claim 12, wherein each of the initial gamma voltages is amplified, and a number of the voltage follower units is equal to a number of the initial gamma voltages.

20. The display apparatus according to claim 12, wherein a part of the initial gamma voltages are amplified, and a number of the voltage follower units is not equal to a number of the initial gamma voltages.
